(19) United States
(12) Patent Application Publication
(10) Pub. No.: US 2009/0098329 A1
(43) Pub. Date: Apr. 16, 2009

(54) DUAL-LAYERED OPTICAL DISC

(75) Inventors: XIAO-HONG HUANG, Shenzhen (CN); SHAN-MING LIAO, Shenzhen (CN)

Correspondence Address: PCE INDUSTRY, INC.;ATT. Steven Reiss, 458 E. LAMBERT ROAD, FULLERTON, CA, 92835, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/951,300

(22) Filed: Dec. 5, 2007

(30) Foreign Application Priority Data
Oct. 11, 2007 (CN) 200710202001.4

(51) Int. Cl. G11B 7/241; G11B 7/24

(52) U.S. Cl. 428/64.5; 428/64.4

(57) ABSTRACT

An exemplary dual-layered optical disc includes a transparent cover layer, a first recording layer, a space layer, a second recording layer, a reflective film, and a substrate, all of which are deposited one upon the other in this order. The first recording layer includes a re-recordable material. The second record layer includes a write-once material. Therefore, the dual-layered optical disc supplies two different types of recording layers.

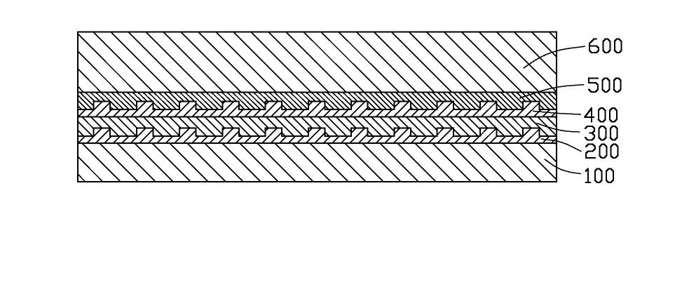

### BACKGROUND

1. Field of the Invention

The present invention relates to optical discs, and particularly to a dual-layered optical disc.

2. Description of Related Art

Recently, a dual-layered optical disc having two recording layers both readable from one side is employed as one of standardized digital video discs (DVDs) and is promising for use as a future high-capacity recording medium.

A conventional dual-layered optical disc of this type generally has a first recording layer, a semitransparent film, a space layer, a reflective film, and a second recording layer, all of which are deposited one upon the other in this order. The first recording layer has a signal pit pattern formed on the semitransparent film side, while the second recording layer has another signal pit pattern formed on the reflective film side. The space layer is intended to separate the two recording layers from each other.

In playing back (reproducing) information stored on the first or second recording layer, the optical disc is set within a playback (reproducing) apparatus so that a laser beam emitted from a pickup head is incident from the first recording layer side. In designing an optical disc or a pickup head, it has been the general practice that a laser beam from the pickup head is best focused on the first recording layer. However, when the focus position at which the laser beam is focused is shifted to the second recording layer for the reading of information stored thereon, the optical path length is extended due to the thickness of the space layer.

### SUMMARY

An exemplary dual-layered optical disc comprising a transparent cover layer, a first recording layer, a space layer, a second recording layer, a reflective film, and a substrate, all of which are deposited one upon the other in this order, wherein the first recording layer includes a re-recordable material and the second recording layer includes a write-once material.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a diagram showing a configuration of a dual-layered optical disc in accordance with the present invention.

### DETAILED DESCRIPTION

Referring to the drawing, a dual-layered optical disc in accordance with an embodiment of the present invention includes a transparent cover layer 100, a first recording layer 200 formed with pits on one face, a space layer 300 composed of the pits of the first recording layer 200 and a reflective film formed on the pits, a second recording layer 400 formed with pits on one face, a reflective film 500 formed on the pits, and a substrate 600. In the optical disc, information is reproduced from a side of the cover layer 100.

In this embodiment of the invention, the write-once material is organic dye. The re-recordable material is phase-changeable material such as metal alloy. In this embodiment of the invention, the metal alloy is consisted of Ag—In—Sb—Te. Therefore, the dual-layered optical disc supplies two different types of recording layers.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dual-layered optical disc comprising a transparent cover layer, a first recording layer, a space layer, a second recording layer, a reflective film, and a substrate, all of which are deposited one upon the other in this order, wherein the first recording layer includes a re-recordable material and the second recording layer includes a write-once material.

2. The dual-layered optical disc as claimed in claim 1, wherein the write-once material is organic dye.

3. The dual-layered optical disc as claimed in claim 1, wherein the re-recordable material is phase-changeable material.

4. The dual-layered optical disc as claimed in claim 3, wherein the phase-changeable material is metal alloy consisted of Ag—In—Sb—Te.
